(19) United States
(12) Patent Application Publication
(10) Pub. No.: US 2017/0346359 A1
(43) Pub. Date: Nov. 30, 2017

(54) AIR PRESSURE ADJUSTER FOR ROTARY ELECTRIC MACHINE

(71) Applicant: HONDA MOTOR CO., LTD., Tokyo (JP)

(72) Inventor: Junya Tachikawa, Wako-shi (JP)

(21) Appl. No.: 15/603,940

(22) Filed: May 24, 2017

(30) Foreign Application Priority Data
May 26, 2016 (JP) 2016-105471

(51) Int. Cl. H02K 3/40; H02K 5/10

(52) U.S. Cl. CPC H02K 3/40; H02K 5/10

(57) ABSTRACT

A air pressure adjuster includes: a rotary electric machine; a casing housing the rotary electric machine hermetically; and an in-casing air pressure adjuster for adjusting an internal air pressure using a drive force generated a difference between the internal air pressure and an outer pressure of the casing. The in-casing air pressure adjuster discharges the air from the inside of the casing to the outside of the casing when the internal air pressure is higher than the external air pressure by a first predetermined value.

### CROSS REFERENCE TO RELATED APPLICATION

This application claims the foreign priority benefit under Title 35, United States Code, §119(a)-(d) of Japanese Patent Application No. 2016-105471, filed on May 26, 2016 in the Japan Patent Office, the disclosure of which is herein incorporated by reference in its entirety.

### BACKGROUND OF THE INVENTION

### 1. Field of the Invention

The present invention relates to an air pressure adjuster for rotary electric machine.

### 2. Description of the Related Art

In an air pressure range where the human can live, a voltage at which a discharge starts between conductors placed in the ambient pressure decreases as the air pressure decreases according to Paschens law. Accordingly, a motor used in, for example, an electric vehicle, a hybrid vehicle, etc. may have a problem in that a discharging, etc. may occur though the motor has a sufficient insulation performance in the lowland because an insulation performance becomes insufficient at a highland.

To compensate the decrease in the insulation performance caused by decrease in the ambient pressure, various technologies have been proposed. For example, JP 4639916 disclosed a technology in which a voltage applied to the motor is decreased when the ambient pressure becomes low. Further, JP 2008-228378 A disclosed a technology in which an air pressure in a room in which the motor is installed is increased with an air compressor. Further, JP 2012-105391 A disclosed a technology in which a tank stores a gas which is supplied to a motor case from the tank.

However, any of the above-described technologies needs complicated structures, which invite an increase in cost of a vehicle, etc. carrying the motor.

### SUMMARY OF THE INVENTION

An aspect of the present invention provides an air pressure adjuster for rotary electric machine capable of keeping an insulation performance by a simple structure.

An aspect of the present invention provides an air pressure adjuster comprising:

a rotary electric machine;

a casing housing the rotary electric machine hermetically; and

an in-casing internal air pressure adjuster for adjusting an internal air pressure using a drive force generated by a difference between the internal air pressure and an external air pressure of the casing.

The in-casing air pressure adjuster may discharge the air from the inside of the casing to the outside of the casing when the internal air pressure is higher than the external air pressure by a first predetermined value. This prevents an error such as detachment of an oil seal in the casing.

The in-casing air pressure adjuster may introduce air from the outside to the inside of the casing when the outer pressure is higher than the internal air pressure by a second predetermined value. This prevents the inside of the casing from being a negative pressure (negative gage pressure) having a large absolute value.

The in-casing air pressure adjuster may include: an elastic body; and a pressure-receiving valve body which opens and closes in accordance with the pressure force pushed by the elastic body.

The in-casing air pressure adjuster may include: a diaphragm: a switching unit that makes switching between communication and non-communication states between the inside and the outside of the casing in accordance with a displacement of the diaphragms.

The air pressure adjuster according to the present invention can maintain the insulation performance of the rotary electric machine with a simple configuration.

### BRIEF DESCRIPTION OF THE DRAWINGS

FIG. 1 is a perspective view of a motor system according to a first embodiment of the present invention.

FIG. 2 is a cross sectional view of the in-casing air pressure adjuster according to the first embodiment.

FIG. 3 is a cross sectional view of the in-casing air pressure adjuster according to a second embodiment.

FIG. 4 is a cross sectional view according to a third embodiment.

### DETAILED DESCRIPTION OF THE INVENTION

### First Embodiment

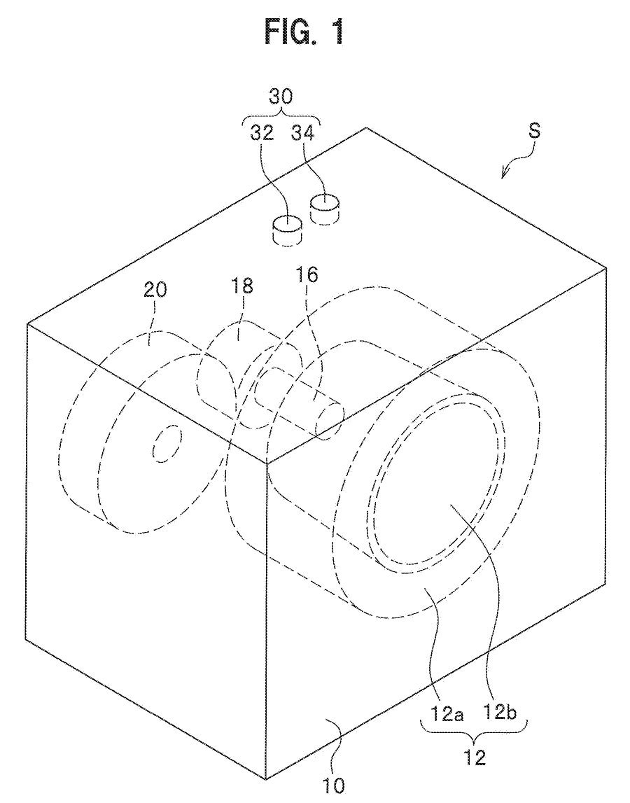

FIG. 1 is a perspective view of a motor system S according to a first embodiment of the present invention.

The motor system (air pressure adjuster for a rotary electric machine) S is used in a vehicle such as an electric vehicle, and a hybrid vehicle.

The motor system S includes a casing 10 having a substantially rectangular shape, a motor (rotary electric machine) 12, a shaft 16, gears 18, 20, and an in-casing internal air pressure adjuster 30.

The motor 12 includes a stator 12a, having a substantially hollow cylindrical shape, being fixed to an inside of the casing 10, and a rotor 12b rotating relative to the stator 12a. The rotor 12b is coupled to the gears 18, 20 through the shaft 16. When the rotor 12b rotates, the shaft 16 and the gears 18, 20 rotate together. The casing 10 houses the motor 12, the shaft 16, and the gears 18, 20 hermetically. The in-casing internal air pressure adjuster 30 includes check valves 32, 34 which adjust the internal air pressure of the casing 10.

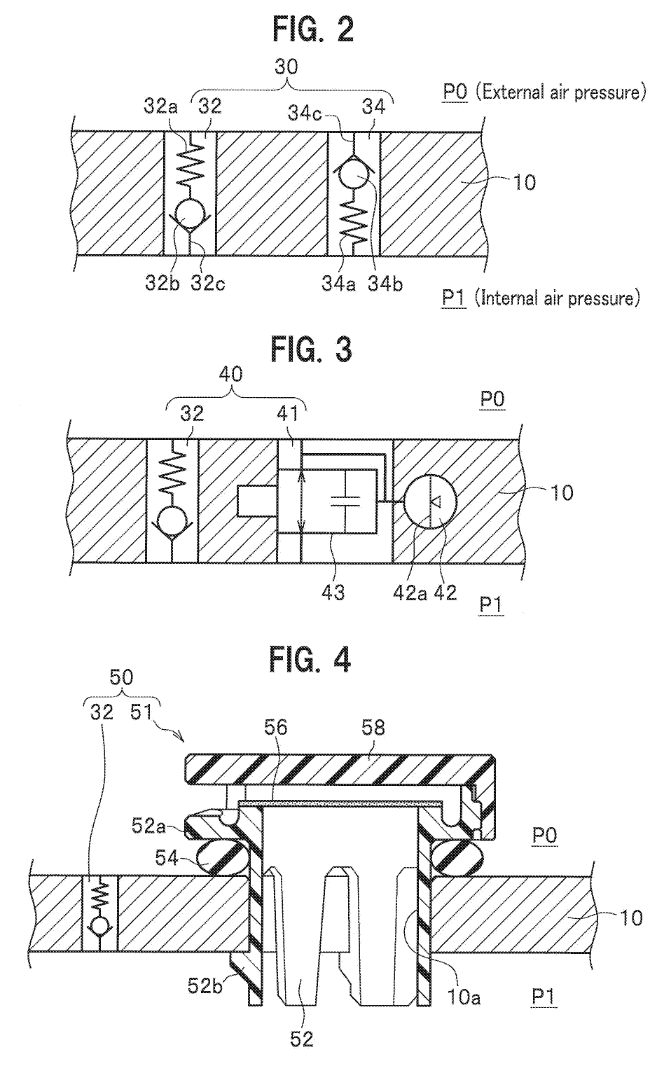

FIG. 2 is a cross-sectional view of the in-casing internal air pressure adjuster 30. The check valve 32 includes a valve seat (pressure-receiving valve body) 32c, a stop valve (pressure-receiving valve body) 32b, and a spring (elastic body) 32a for pressing the stop valve 32b to the valve seat 32c. Accordingly, the check valve 32 discharges the air in the casing 10 to the outside when an internal pressure P1, which is an internal air pressure in the casing 10, is higher than an external air pressure P0, which is an air pressure outside the casing 10, by more than a predetermined pressure difference ΔPA (first predetermined value).

The external air pressure P0 is an ambient pressure in the first embodiment. Further, it is preferable that the air pressure difference ΔPA at which the check valve 32 starts operation is in a range not lower than 0.01 MPa and not higher than 0.1 MPa and more preferable that the range is not lower than 0.03 MPa and not higher than 0.04 MPa. This is because when the internal pressure P1 increases due to a temperature increase, etc. of the motor 12, if the air pressure difference ΔPA is allowed to be accessibly high, an oil seal (not shown) is detached, etc. and when the pressure difference ΔPA is allowed to be excessively low, it becomes difficult to keep the sufficient internal pressure P1 to keep the insulation performance.

A check valve 34 includes a valve seat body 34c (pressure-receiving valve body), a stop valve 34b (pressure-receiving valve body), and a spring 34a (elastic body) for pressing the stop valve 34b on the valve seat body 34c. Accordingly, the check valve 34 introduces the air to the inside of the casing 10 from the outside when the external air pressure P0 is higher than the internal pressure P1 by more than ΔPB (second predetermined value).

The check valve 34 has a function of making the internal pressure P1 closer to the external air pressure P0 when the location is a lowland, etc. where the external air pressure P0 is significantly high. Further, the check valve 34 prevents that the inside of the casing 10 has a negative air pressure from the outside when the casing 10 is rapidly cooled. Accordingly, it is preferable that the air pressure difference ΔPB at which the check valve 34 operates is set to have so small as possible as the situation allows in such a range that the check valve 34 does not open due to vibrations, etc. More specifically, it is preferable that the air pressure difference ΔPB is in such a range as to be not lower than 0.001 MPa and not higher than 0.01 MPa and further preferable that the air pressure difference ΔPB is in such a range as to be not lower than 0.003 MPa and not higher than 0.004 MPa.

As described above, according to the first embodiment, because “ΔPA>ΔPB” is set, when the external air pressure P0 increases, the internal pressure P1 tends to increase according to the external air pressure P0. On the other hand, when the external air pressure P0 decreases, the internal pressure P1 hardly decreases. Accordingly, though the external air pressure P0 decreases at a highland, etc., the in-casing internal air pressure adjuster 30 can keep the internal pressure P1 at a relative high value, it is possible to keep the insulation performance of the motor 12 with a simple structure.

### Second Embodiment

Next, the motor system according to the second embodiment is described below.

A general structure of the second embodiment is the same as that of the first embodiment shown in FIG. 1. However, in the second embodiment, an in-casing internal air pressure adjuster 40 is installed to the casing 10 shown in FIG. 3 in place of the in-casing internal air pressure adjuster 30 in the first embodiment.

The in-casing internal air pressure adjuster 40 includes a diaphragm valve 41 and the check valve 32. The diaphragm valve 41 includes an air chamber 42 and a switching device 43. The air chamber 42 includes a diaphragm 42a which separates the external air pressure P0 and the internal pressure P1 and is displaced in accordance with an air pressure difference between the external air pressure P0 and the internal pressure P1.

The switching device 43 connected to the diaphragm 12a makes switching between communication and non-communication between outside and the inside of the casing 10 by the displacement according to the positional displacement of the diaphragm 42a. More specifically, the switching device 43 makes communication between the external air and the internal air of the casing 10 when the external air pressure P0 is higher than the internal pressure P1 by the air pressure difference ΔPB or more. Further, the check valve 32 discharges the air inside the casing 10 when the internal pressure P1 is higher than the external air pressure P0 by the air pressure difference ΔPA or more similarly to the check valve 32 in the first embodiment. Values of the air pressure differences ΔPA, ΔPB are the same as those in the first embodiment.

As described above, according to the second embodiment, though the external air pressure P0 decreases at a highland, etc. the internal pressure P1 can be maintained to have a higher value by the in-casing internal air pressure adjuster 40, which can keep the insulation performance of the motor 12 with a simple structure.

### Third Embodiment

Next, a motor system according to a third embodiment is described below.

A general structure of the third embodiment is the same as that of the first embodiment shown in FIG. 1. However, in the third embodiment, an in-casing internal air pressure adjuster 50 is installed to the casing 10 shown in FIG. 4 in place of the in-casing internal air pressure adjuster 30 in the first embodiment.

The in-casing internal air pressure adjuster 50 includes a porous valve 51 and the check valve 32. The porous valve 51 includes an attaching part 52, a ring-shape packing 54, a porous membrane 56, and a cover 58. The attaching part 52 is formed in substantially hollow cylindrical shape inserted into a circular through hole 10a formed in the casing 10. The attaching part 52 is formed to have a flange 52a at one end thereof (an upper end in FIG. 4) and a stopper 52b at the other end. The ring-shape packing 54 is inserted between the flange 52a and the casing 10. The flange 52a and the stopper 52b pinch the ring-shape packing 54 and the casing 10 with pressure.

The attaching part 52 has an opening at the flange 52a and the porous membrane 56 having a circular disk shape covers the opening and is fixed to the flange 52a surrounding the opening. The cover 58 circumferentially covers the porous membrane 56 so as to allow the external air to be in contact with the porous membrane 56 to prevent a foreign material from being in contact with the porous membrane 56. The porous membrane 56 has a function to allow the air to pass therethrough between the outside and the inside of the casing 10 when a difference (absolute value) between the internal air pressure P1 and the external air pressure P0 is equal to or higher than the air pressure difference ΔPB.

Further, the check valve 32 discharges the air inside the casing 10 when the internal pressure P1 is higher than the external air pressure P0 by the air pressure difference ΔPA or more similarly to the check valve 32 in the first embodiment. Preferable values of the air pressure differences ΔPA, ΔPB are the same as those in the first embodiment. As the porous valve 51, Vent Filters having a name of TEMISH (registered trademark) or CAPSEAL (trademark) by NITTO DENKO CORPORATION are usable.

As described above, according to the third embodiment, though the external air pressure P0 decreases due to a highland, etc., it is possible to keep the internal air pressure P1 at a relatively high value, so that the insulation performance of the motor 12 can be maintained with a simple structure similarly to the first embodiment.

### Modifications

The present invention is not limited to the above-described embodiments and may be modified in various modifications. The present invention is not limited to the configuration including all elements described in the above-described embodiments. Further, a part of a configuration of one of the embodiments can be replaced with a corresponding element in another embodiment or added to another embodiment. Further, a part of a configuration of one of the embodiments can be omitted, and another configuration may be added or replaced with. For example, there are modifications as follows:

In the above-described embodiments, the external air pressure P0 is “ambient air pressure”. However, any air pressure other than the ambient air pressure may be applied. For example, in a case where the above-described embodiments are applied to a hybrid vehicle, the in-casing internal air pressure adjuster 30 is installed in an air flow passage for air compressed by a super charger. In this case, “external air pressure P0” is a pressure of air compressed by a supercharger.

Further, the motor systems according to the first to third embodiments are applicable to not only electric vehicles, hybrid vehicles, etc. but also various electric products and plant equipment.

The invention claimed is:

1. An air pressure adjuster comprising:
a rotary electric machine;
a casing housing the rotary electric machine hermetically; and
an in-casing air pressure adjuster that adjusts an internal air pressure using a drive force generated by a difference between the internal air pressure and an outer pressure of the casing.

2. The air pressure adjuster according to claim 1, wherein the in-casing air pressure adjuster discharges the air from the inside of the casing to the outside of the casing when the internal air pressure is higher than the external air pressure by a first predetermined value.

3. The air pressure adjuster according to claim 1, wherein the in-casing air pressure adjuster introduces air from the outside to the inside of the casing when the outer pressure is higher than the internal air pressure by a second predetermined value.

4. The air pressure adjuster according to claim 1, wherein the in-casing air pressure adjuster comprises:
an elastic body; and
a pressure-receiving valve body which opens and closes in accordance with the pressure force pushed by the elastic body.

5. The air pressure adjuster according to claim 1, wherein the in-casing air pressure adjuster comprises:
a diaphragm:
a switching unit that makes switching between communication and non-communication states between the inside and the outside of the casing in accordance with a displacement of the diaphragms.

6. The air pressure adjuster according to claim 2, wherein the first predetermined value is not smaller than 0.01 MPa and not higher than 0.1 MPa.

7. The air pressure adjuster according to claim 3, wherein the second predetermined value is not smaller than 0.01 MPa and not higher than 0.1 MPa.

8. The air pressure adjuster according to claim 2, wherein the in-casing air pressure adjuster introduces air from the outside to the inside of the casing when the outer pressure is higher than the internal air pressure by a second predetermined value.
